(19) United States
(12) Patent Application Publication
(10) Pub. No.: US 2024/0393303 A1
(43) Pub. Date: Nov. 28, 2024

(54) METHODS OF MASS SPECTROMETRY, A MASS SPECTROMETER AND COMPUTER SOFTWARE

(71) Applicant: Thermo Fisher Scientific (Bremen) GmbH, Bremen (DE)

(72) Inventors: Hamish Stewart, Bremen (DE); Alexander Makarov, Bremen (DE)

(73) Assignee: Thermo Fisher Scientific (Bremen) GmbH, Bremen (DE)

(21) Appl. No.: 18/672,554

(22) Filed: May 23, 2024

(30) Foreign Application Priority Data
May 23, 2023 (GB) 2307712.6

(51) Int. Cl. G01N 30/86; G01N 30/02; G01N 30/72; H01J 49/40

(52) U.S. Cl. CPC G01N 30/8696; G01N 30/7233; G01N 30/8631; H01J 49/405; G01N 2030/027

(57) ABSTRACT

A method of mass spectrometry is provided. The method comprises performing the following steps for each of a plurality of sub-ranges selected from an overall m/z range: accumulating in an ion store a sample of precursor ions to be analysed, the precursor ions having m/z values within the sub-range; accumulating in the ion store a sample of fragmented precursor ions to be analysed, the fragmented precursor ions being formed from fragmentation of precursor ions having m/z values within the sub-range; and simultaneously analysing the combined samples of the precursor ions and the fragmented precursor ions in a mass analyser.

### CROSS REFERENCE TO RELATED APPLICATION

This application claims priority to application GB2307712.6, filed May 23, 2023. The entire disclosure of GB2307712.6 is incorporated herein by reference.

### FIELD OF THE INVENTION

The field of this this invention is liquid chromatography mass spectrometry (LC-MS). In particular, this invention relates to tandem mass spectrometry where precursor ions and fragment ions are analysed. More particularly, the invention relates to improving the dynamic range of an MS1 scan in tandem mass spectrometry. The invention is relevant particularly, although not exclusively, to advanced hybrid mass spectrometers with multiple analysers.

### BACKGROUND

Standard tandem liquid chromatography mass spectrometry (LC-MS) methods include performing “MS1” scans, where ions having a wide range of m/z are analysed by a mass analyser to produce an MS1 spectrum (containing information about precursor ions). Methods of operating a LC-MS further involve the isolation and fragmentation of ions from eluted analyte species in order to perform “MS2” scans, where a narrow m/z range of ions is isolated (e.g., using a quadrupole mass filter), those ions are fragmented, and the fragment ions are mass analysed to produce an MS2 spectrum, containing structural and quantitative information about fragment ions.

In LC-MS methods, multiple MS2 scans are typically performed during a chromatographic separation, where the m/z isolation range is different for each MS2 scan. The MS2 (or “MS/MS”) spectra are supported by the MS1 (or “MS” or “Full-MS”) survey scans, which provide high quality peak information such as accurate mass data and precursor intensity of a wide range of unfragmented precursor ions.

For Data Independent Acquisition (DIA) methods, the MS1 scan is optional and may be skipped to allow time to generate additional MS2 spectra. A list of m/z targets for each of the plural MS2 scans can be a stepwise increasing/decreasing list of m/z across an m/z range of interest. An example of this is described in EP 3,410,463, which is herein incorporated by reference. The resulting precursor information can be used for quantitation, while fragment information can be used for identification.

In Data Dependent Acquisition (DDA), the MS1 step is required to generate a list of precursor targets for MS2 analysis. The list of m/z targets for each of the plural MS2 scans corresponds to a list of precursors ions identified in an MS1 scan.

To mass analyse ions, ions (fragment ions or precursor ions) are commonly first accumulated in an ion trap, and then the accumulated ions are ejected as a packet into the mass analyser for mass analysis. Accumulation improves the sensitivity of the instrument but requires careful (so-called “Automatic Gain Control”, AGC) over the fill time of ions into the ion trap to avoid detrimental space charge effects.

One problem with existing methods is that the dynamic range of the MS1 spectrum is limited. Digested peptide concentration varies by up to 10 orders of magnitude, but the dynamic range of a single shot spectrum in, for example, an electrostatic orbital trap mass analyser (such as an Orbitrap™ FT mass analyser made by Thermo Fisher Scientific™) may be limited to around 4 orders of magnitude. Furthermore, the number of ions that may be injected into the orbital trap mass analyser is limited by the capacity of the accumulating C-Trap to approximately 105. Consequently, low intensity peptide precursor signals may be overwhelmed. For DDA experiments, these issues are significant and could result in precursor targets being missed. For DIA experiments, a lack of good precursor data hinders identification and quantitation.

One method to improve the dynamic range of the MS1 spectrum is the “Boxcar” method (as described in Meier et al, Nature Methods, 2018, 15, 440-448), and the high dynamic range (HDR) method described in UK Patent Application Number 2211790.7, which is herein incorporated by reference. In these approaches, the wide mass range of the analysis is subdivided into a number of narrower isolation windows. For each isolation window, a separate injection is made into the C-Trap, with a differing fill time dependent on the ion current. By this method heavily populated m/z regions are attenuated and sparsely populated m/z regions are amplified. Thus, detection sensitivity for relatively weak peaks is improved and the effective dynamic range of the scan is increased. However, use of these methods significantly increases the time required to accumulate ions, especially when a substantial number of isolation windows are required. Because of the long fill times for low-level windows, and the time required to switch the quadrupole and ion source voltages, HDR scanning may require a significant amount of additional time and impact the rate at which MS2 scans may be made. Therefore, these methods may decrease the time available for MS2 scans in fast LC-MS methods, which are limited by the time taken for the sample to elute from the chromatography column.

Multiple-window HDR methods also suffer from the drawback of discarding a considerable number of ions due to quadrupole isolation. Loss of ions may be addressed via a pre-accumulation process. For example, trapped ion mobility devices may be used to pre-accumulate ions prior to a quadrupole and release them in a mass/mobility dependent manner synchronized to the mass filter, greatly reducing ion losses (as described in Meier et al, Molecular & Cellular Proteomics, 2018, 17, 2534-2545).

Differential mobility filtration may be used to improve proteomics performance by removing analytically less useful singly charged ions from the accumulated population (as described in Hebert et al, Anal. Chem., 2018, 90, 9529-9537). This may be advantageous in low sample or single cell experiments, where the analyte signal is small in comparison to the singly charged solvent background signal.

In DIA experiments, MS2 spectra may retain a proportion of unfragmented precursor ions (in quantities that are insufficient to be analytically useful). Some Orbitrap instruments offer an optional feature called “Stepped Collision Energy,” which is described in U.S. Pat. No. 9,536,717 This feature provides multiple separate injections into a collision cell (also referred to as a “fragmentation chamber”) at a range of collision energies, the summed population of ions are then transferred to the C-Trap/Orbitrap mass analyser and analysed together. This variation in energies improves the probability that one of the energies used is optimal for fragmenting the precursor ion. However, this approach also uses many collision energies that are not optimal for fragmenting the precursor ion, with the associated cost of ion beam time. The actual action of changing collision energy and making a second or third injection into a collision cell may not be overly time-intensive, perhaps an additional 1-3 ms overhead on a >40 ms scan cycle, in some cases.

U.S. Pat. No. 8,686,350 describes a method in which different types of ions can be accumulated in an ion trap before being ejected into a mass analyser. In one example, a combination of two types of ion with the same narrow mass range are injected into the ion trap, one fragmented and one left as intact precursor. This allows greater confidence that precursor ions may be detected and accurately mass measured. However, quantitation may suffer from the proportion of unfragmented precursor left over from the MS2 injection.

### SUMMARY

A method of mass spectrometry is provided. The method comprises performing the following steps for each of a plurality of sub-ranges selected from an overall m/z range:
accumulating in an ion store a sample of precursor ions to be analysed, the precursor ions having m/z values within the sub-range;
accumulating in the ion store a sample of fragmented precursor ions to be analysed, the fragmented precursor ions being formed from fragmentation of precursor ions having m/z values within the sub-range; and
simultaneously analysing the combined samples of the precursor ions and the fragmented precursor ions in a mass analyser.

In the method, a plurality of MS2 scans are performed in respect of a list of m/z target sub-ranges (in a DDA experiment or, more preferably, in a DIA experiment). For at least some (and preferably all) of the MS2 scans, precursor ion information is obtained together with the usual fragment ion information. Each set of precursor information and fragment information is obtained at the same time or concurrently in time, without altering the quadrupole mass filter's settings. The precursor information in respect of each MS2 scan is for a narrow m/z sub-range (and so comprises information equivalent to a so-called “selected ion monitoring”, SIM scan).

The precursor information from the scans for all of the sub-ranges can be combined to effectively create a complete (at least in a DIA experiment where the list of m/z targets spans the wide m/z range of interest) or otherwise partially complete MS1 spectrum spanning the overall m/z range of interest. The method therefore performs SIM and MS2 scans in parallel for improved quantitation of accumulated ions.

By building an MS1 spectrum from multiple narrow m/z sub-ranges, each m/z sub-range can be acquired using a tailored fill time, so that the dynamic range of the overall MS1 spectrum can be improved (in a similar manner to the “Boxcar” or HDR methods). However, unlike the “Boxcar” or HDR methods, the method disclosed herein is done in a manner that reduces the additional time required to obtain the MS1 data (and so is more compatible with fast LC-MS experiments). This is achieved, at least in part, because the quadrupole mass filter's sequence is not altered from the sequence it would follow in respect of the list of m/z targets for the plural MS2 scans.

In this first method, each set of precursor and fragment information is acquired in one combined scan, preferably using a method such as the one described in U.S. Pat. No. 8,686,350.

In this first method, the SIM and MS2 ions are combined in a single scan. In this way, the time required to obtain MS1 and MS2 data is reduced.

Moreover, by splitting the overall m/z range into a plurality of sub-ranges, a special DIA method that minimises source/quadrupole transition times may be provided. Optionally, the sub-ranges may be stepped through sequentially, so that small adjustments are made to the ion filter between sub-ranges.

This combination of features is not known from any of the prior art described above.

A further advantage of the method is to build up a high quality HDR scan, or equivalent precursor data from many scans, suitable for quantitation of a wide dynamic range of analyte ions. Performing such a scan normally would involve prolonged delays to switch the ion source and quadrupole to scan through the mass range independent of the DIA cycle. Such a process costs a substantial proportion of ion beamtime, as the number of ions to be processed for an HDR scan is high. Therefore, by the method described herein, significant time savings may be realised and improved efficiency may be achieved. Where time available is limited (such as in LC-MS), it may be possible to achieve greater resolution in the available time by employing the methods described herein.

The method may further comprise estimating a quantity of unfragmented precursor ions accumulated in the ion store during accumulation of fragmented precursor ions.

In the first method, unfragmented precursor ions may be present amongst the MS2 fragment ions. These unfragmented ions will be mixed in the ion trap with the SIM precursor ions. This may obfuscate the accurate quantitative information provided by the SIM precursor ions. This problem may be addressed by predicting (and then correcting for) the quantity of unfragmented precursor ions present in the MS2 fragment ions.

By accounting for residual precursor ions from the MS2 injection (e.g., using AI tools post-identification), data from the SIM portion of the scan may be used for accurate quantitation.

The SIM data from each sub-range (corrected to account for residual precursor ions from the MS2 injection) may be combined to provide a high-resolution MS1 scan for the overall m/z range (if the sub-ranges are contiguous and fully cover the overall range).

The quantity of unfragmented precursor ions may be predicted using a data analysis tool such as the CHIMERYS™ search engine by MSAID™.

The method may further comprise obtaining scan data from the simultaneous analysis of the combined samples.

Estimating a quantity of unfragmented precursor ions may be performed using software configured to deconvolute a plurality of fragment spectra from the scan data, wherein the plurality of fragment spectra are selected from a database of fragment spectra.

Estimating a quantity of unfragmented precursor ions may be performed using a neural network configured to deconvolute a plurality of fragment spectra from the scan data, wherein the plurality of fragment spectra correspond to a plurality of precursor ion species.

Estimating a quantity of unfragmented precursor ions may be performed using a neural network configured to predict fragment spectra for the precursor ions, including intensities of m/z peaks.

The method may further comprise configuring an ion filter to transmit precursor ions having m/z values within the sub-range.

Configuring the ion filter may comprise setting a transmission window of the ion filter. The transmission window may be adjusted between each of the plurality of sub-ranges. For each sub-range, the transmission window for the step of accumulating the sample of precursor ions may be the same as the transmission window for the step of accumulating the sample of fragmented precursor ions. In other words, the transmission window may not be adjusted between these steps.

The method may further comprise configuring an ion mobility separator to transfer precursor ions having m/z values within the sub-range to the ion filter.

The method may further comprise controlling the ion mobility separator so that the precursor ions transferred to the ion filter correspond with a transmission window of the ion filter, for each of the plurality of sub-ranges in the overall m/z range.

The mass analyser may be a time-of-flight, ToF, analyser such as a multi-reflection time-of-flight, MR-ToF, analyser.

The mass analyser may be a Fourier Transform mass analyser (e.g., an Orbitrap™ mass analyser).

Accumulating the sample of precursor ions may comprise controlling a fill time for the precursor ions, based on a relative abundance of precursor ion species in the corresponding sub-range. This may improve the dynamic range of the MS1 scan produced by combining the SIM scans.

The fragmented precursor ions may be formed from fragmentation of precursor ions having m/z values within the sub-range at a plurality of different collision energies. A separate ion accumulation step may be performed for each collision energy to accumulate all of the fragments in the ion store.

The plurality of sub-ranges may be contiguous (and may be combined to make up the full m/z range).

The method may further comprise, for each sub-range, obtaining scan data relating to the precursor ions. The method may further comprise combining the scan data relating to the precursor ions for each sub-range to form a high-definition scan for the overall m/z range.

Combining SIM scan data (relating to the precursor ions for each sub-range) may be particularly useful where the sub-ranges are contiguous and/or completely cover the overall m/z range. In such cases, the combined SIM scan data may be used to form a high-definition scan for the overall m/z range.

The overall m/z range may comprise a second plurality of sub-ranges that are non-overlapping with the plurality of sub-ranges. The method may further comprise, for each of the second plurality of sub-ranges, analysing, in a mass analyser, a sample of fragmented precursor ions formed from fragmentation of precursor ions having m/z values within the sub-range.

In other words, a SIM scan may not be needed for some of the sub-ranges and MS2-only scans may be performed for these sub-ranges. These may be sub-ranges of the overall m/z range that comprise high-intensity precursor peaks in an MS1 scan.

In some variations of the methods, it may be preferable not to perform SIM scans for m/z sub-ranges of the overall precursor mass range that are already heavily populated. Full-MS scans may be used to determine which m/z sub-ranges of the overall precursor mass range are already heavily populated. The full-MS scan should be able to gather sufficient data for such regions by themselves. Omitting SIM scans for these sub-ranges may further reduce the time required for the overall method. A HDR MS1 scan can be obtained by combining the full-MS1 scan with the SIM scans.

Each of the plurality of sub-ranges may have the same width. In other words, the m/z range of each sub-range may be equal. The width of the sub-ranges may be pre-set, ahead of the scan. Where the sub-ranges are determined ahead of time, the method may be referred to as a data independent acquisition, DIA, method.

The method may further comprise analysing a sample of precursor ions having m/z values from the overall m/z range (i.e., not mass filtered) in a mass analyser.

Analysing the sample of precursor ions having m/z values from the overall m/z range may comprise obtaining scan data for the overall m/z range.

The method may further comprise, for each sub-range, obtaining scan data relating to the precursor ions. The method may further comprise augmenting the scan data for the overall m/z range using the scan data relating to the precursor ions for each sub-range, to form a high-definition scan for the overall m/z range.

Augmenting the scan data for the overall m/z range may be useful where the sub-ranges are not contiguous and/or do not completely cover the overall m/z range. By augmenting specific regions of the MS1 scan with SIM data, a HDR scan may be obtained.

The method may further comprise, for each sub-range, obtaining scan data relating to the precursor ions. The method may further comprise comparing the scan data for the overall m/z range to the scan data relating to the precursor ions for each sub-range, and adjusting one of the scan data for the overall m/z range or the scan data relating to the precursor ions for each sub-range based on the other of the scan data for the overall m/z range or the scan data relating to the precursor ions for each sub-range.

In other words, comparing SIM data to full scan data and correcting one of the data sets based on the other one. SIM scanned precursor ions may be compared to the full MS and used as an internal calibrant, this is especially useful when SIM scans are performed by a jitter-prone MR-ToF analyser and full MS by a more stable Orbitrap analyser, in a hybrid instrument.

The method may further comprise determining the plurality of sub-ranges from the overall m/z range, based on scan data obtained from analysis of the sample of precursor ions having m/z values from the overall m/z range. Where the sub-ranges are based on MS1 data, the method may be a DDA method.

The plurality of sub-ranges may comprise a first sub-range and a second sub-range.

The step of analysing the combined samples of the precursor ions and the fragmented precursor ions from the first sub-range may at least partially overlap (in time) with the step of accumulating the sample of precursor ions having m/z values within the second sub-range.

The step of analysing the combined samples of the precursor ions and the fragmented precursor ions from the first sub-range may at least partially overlap (in time) with the step of accumulating the sample of fragmented precursor ions formed from fragmentation of precursor ions having m/z values within the second sub-range.

Some steps for the next sub-range may be performed while other steps from the previous sub-range are still ongoing. In other words, parallelism may be employed to reduce the overall time taken to perform the scans.

There may also be overlap (in time) between steps within a sub-range. For example, injection of precursor ions into the ion store may be performed in parallel with fragmentation of precursor ions.

For each sub-range, the step of accumulating the sample of precursor ions may be performed prior to the step of accumulating the sample of fragmented precursor ions.

Alternatively, for each sub-range, the step of accumulating the sample of fragmented precursor ions is performed prior to the step of accumulating the sample of precursor ions.

In other words, the order of injection of the ions is either precursor ions followed by fragment ions, or fragment ions followed by precursor ions.

The method may further comprise adjusting a collision energy used for fragmentation of the precursor ions between the step of accumulating the sample of precursor ions and the step of accumulating the sample of fragmented precursor ions.

The method further may further comprise cooling the fragmented precursor ions. This especially applies when the step of accumulating the sample of fragmented precursor ions is performed prior to the step of accumulating the sample of precursor ions.

The method may be performed within a time period based on a width of a chromatographic peak of the sample as it elutes from a chromatography system.

The method may further comprise ionising the sample to produce the precursor ions.

The method may further comprise fragmenting the precursor ions to produce the fragmented precursor ions.

The precursor ions may be fragmented in a collision cell such as an Ion Routing Multipole, IRM, collision cell.

The method may further comprise performing quantitation of the precursor ions based on scan data relating to the precursor ions. Quantitation may be performed using data relating to the MS1 domain.

The method may further comprise performing identification of the precursor ions based on scan data relating to the fragmented precursor ions. Identification may be performed using data relating to the MS2 domain.

A second method of mass spectrometry is provided. The second method comprises the steps of:
for each of a plurality of sub-ranges selected from an overall m/z range:
   configuring an ion filter to transmit precursor ions having m/z values within the sub-range;
   analysing a sample of the precursor ions received from the configured ion filter in a mass analyser; and
   analysing a sample of fragment ions that are produced by fragmenting precursor ions received from the configured ion filter in the mass analyser.

In the alternative method, as with the first method described above, plural MS2 scans are performed in respect of a list of m/z target sub-ranges (in a DDA experiment or more preferably in a DIA experiment). For at least some (and preferably all) of the MS2 scans, precursor ion information is obtained with the usual fragment ion information. However, unlike the first method, which uses a single scan for the MS2 and SIM ions in each sub-range (with multiple injections for each scan), the second method makes multiple scans for each sub-range.

The fragment ions and the precursor ions are analysed in the same mass analyser, sequentially in time, without altering the quadrupole mass filter's settings.

The precursor information in respect of each MS2 scan is for a narrow m/z sub-range (and so comprises information equivalent to a so-called “selected ion monitoring”, SIM scan).

As with the first method described above, the precursor information from the scans for all of the sub-ranges obtained in the second method can be combined to effectively create a complete (at least in a DIA experiment where the list of m/z targets spans the wide m/z range of interest) or otherwise partially complete MS1 spectrum spanning the overall m/z range of interest. The method may therefore perform SIM and MS2 scans in parallel for improved quantitation of accumulated ions.

As with the first method, an MS1 spectrum may be built from multiple m/z sub-ranges. Each m/z sub-range can be acquired using a tailored fill time, so that the dynamic range of the overall MS1 spectrum can be improved. The overall time required to obtain the MS1 data may be reduced by performing the SIM scans in parallel with the MS2 scans. In this way, the quadrupole mass filter's sequence is not altered from the sequence it would follow in respect of the list of m/z targets for the plural MS2 scans. As such, the method is compatible with fast LC-MS experiments.

The second method comprises separate steps of analysing the sample of the precursor ions and analysing the sample of fragment ions. In other words, the precursor and fragment information is acquired in separate scans.

The mass analyser used to perform the scans may be a time-of-flight, ToF, analyser such as a multi-reflection time-of-flight, MR-ToF, analyser.

Analysing a sample of the precursor ions may comprise passing the precursor ions through the ToF analyser a plurality of times. The SIM scan may be obtained in the ToF analyser via a process known as “Zoom Mode”, in which a mass sub-range undergoes multiple passes through the ToF analyser to produce higher resolution.

Alternatively, the mass analyser may be a Fourier Transform mass analyser (e.g., an Orbitrap™ mass analyser).

Analysing a sample of the precursor ions may produce a time-varying transient signal, and the method may further comprises producing a mass spectrum from the time-varying transient signal using a phase-constrained spectrum deconvolution method (ϕSDM), optionally limited to the precursor frequency range.

The method may further comprise accumulating the sample of precursor ions in an ion store. Accumulating the sample of precursor ions in the ion store may comprise controlling a fill time for the precursor ions, based on a relative abundance of precursor ion species in the corresponding sub-range.

The method may further comprise accumulating the sample of fragmented precursor ions in an ion store. The fragment ions and the precursor ions may be accumulated sequentially in the same ion store.

A front-end accumulation device, such as an ion mobility separator such as a Trapped Ion Mobility Separator (as incorporated into the Bruker TIMS-ToF series of mass spectrometers), may be used (and would be advantageous to the methods described herein). Such a device may release ions in an m/z range synchronised to the quadrupole isolation window. As a result, ion transmission is greatly boosted. As a further result, the required injection time may be reduced (due to a brighter isolated ion beam). This reduction in injection time may be used to offset the additional time overhead of the SIM injections.

The method may further comprise configuring an ion mobility separator to transfer precursor ions having m/z values within the sub-range to the ion filter.

The method may further comprise controlling the ion mobility separator so that the precursor ions transferred to the ion filter correspond with a transmission window of the ion filter, for each of the plurality of sub-ranges in the overall m/z range.

The fragmented precursor ions may be formed from fragmentation of precursor ions having m/z values within the sub-range at a plurality of different collision energies.

There may be a separate accumulation step for each collision energy.

The method may further comprise, for each of the plurality of different collision energies:
fragmenting the precursor ions at the respective collision energy to produce a portion of the sample of fragmented precursor ions; and
accumulating the portion of the sample of fragmented precursor ions in the ion store.

In other words, the method may comprise analysing (in a mass analyser) a sample of fragment ions that are produced by fragmenting precursor ions received from the configured ion filter at a plurality of different collision energies. The fragments produced at different collision energies may be accumulated together in the ion store.

The plurality of sub-ranges may be contiguous. The plurality of sub-ranges may be combinable to make up the overall m/z range.

The method may further comprise, for each sub-range, obtaining scan data relating to the precursor ions. The method may further comprise combining the scan data relating to the precursor ions for each sub-range to form a high-definition scan for the overall m/z range.

Combining SIM scan data (relating to the precursor ions for each sub-range) may be particularly useful where the sub-ranges are contiguous and/or completely cover the overall m/z range. In such cases, the combined SIM scan data may be used to form a high-definition scan for the overall m/z range.

The overall m/z range may comprise a second plurality of sub-ranges that are non-overlapping with the plurality of sub-ranges. The method may further comprise, for each of the second plurality of sub-ranges, analysing, in a mass analyser, a sample of fragmented precursor ions formed from fragmentation of precursor ions having m/z values within the sub-range.

In other words, a SIM scan may not be needed for some of the sub-ranges and MS2-only scans may be performed for these sub-ranges. These may be sub-ranges of the overall m/z range that comprise high-intensity precursor peaks in an MS1 scan.

In some variations of the methods, it may be preferable not to perform SIM scans for m/z sub-ranges of the overall precursor mass range that are already heavily populated. Full-MS scans may be used to determine which m/z sub-ranges of the overall precursor mass range are already heavily populated. The full-MS scan should be able to gather sufficient data for such regions by themselves. Omitting SIM scans for these sub-ranges may further reduce the time required for the overall method. A HDR MS1 scan can be obtained by combining the full-MS1 scan with the SIM scans.

Each of the plurality of sub-ranges may have a same width. The width may be set ahead of the scan. The method may be a DIA method.

The method may further comprise analysing a sample of precursor ions having m/z values from the overall m/z range (i.e., not mass filtered) in a mass analyser.

Analysing the sample of precursor ions having m/z values from the overall m/z range may comprise obtaining scan data for the overall m/z range.

The method may further comprise, for each sub-range, obtaining scan data relating to the precursor ions. The method may further comprise augmenting the scan data for the overall m/z range using the scan data relating to the precursor ions for each sub-range, to form a high-definition scan for the overall m/z range.

Augmenting the scan data for the overall m/z range may be useful where the sub-ranges are not contiguous and/or do not completely cover the overall m/z range. By augmenting specific regions of the MS1 scan with SIM data, a HDR scan may be obtained.

The method may further comprise, for each sub-range, obtaining scan data relating to the precursor ions. The method may further comprise comparing the scan data for the overall m/z range to the scan data relating to the precursor ions for each sub-range, and adjusting one of the scan data for the overall m/z range or the scan data relating to the precursor ions for each sub-range based on the other of the scan data for the overall m/z range or the scan data relating to the precursor ions for each sub-range.

In other words, comparing SIM data to full scan data and correcting one of the data sets based on the other one. SIM scanned precursor ions may be compared to the full MS and used as an internal calibrant, this is especially useful when SIM scans are performed by a jitter-prone MR-ToF analyser and full MS by a more stable Orbitrap analyser, in a hybrid instrument.

The method may further comprise determining the plurality of sub-ranges from the overall m/z range, based on scan data obtained from analysis of the sample of precursor ions having m/z values from the overall m/z range. Where the sub-ranges are based on MS1 data, the method may be a DDA method.

The method may further comprise adjusting a collision energy of a fragmentation chamber used for fragmenting the precursor ions. Precursor ions from the ion filter may pass through the fragmentation chamber before being accumulated in an ion store. The collision energy of the fragmentation chamber may be adjusted between the step of accumulating the sample of precursor ions in the ion store and the step of accumulating the sample of fragmented ions in the ion store. Prior to accumulating the sample of precursor ions in the ion store, the precursor ions from the ion filter may pass through the fragmentation chamber at a collision energy setting below a threshold or at a setting of zero collision energy.

Alternatively, prior to accumulating the sample of precursor ions in the ion store, the precursor ions may pass from the ion filter to the ion store, bypassing the fragmentation chamber.

The method may be performed within a time period based on a width of a chromatographic peak of the sample as it elutes from a chromatography system.

The method may further comprise ionising the sample to produce the precursor ions.

The method may further comprise fragmenting the precursor ions to produce the fragmented precursor ions.

The precursor ions may be fragmented in a collision cell such as an Ion Routing Multipole, IRM, collision cell.

The method may further comprise performing quantitation of the precursor ions based on scan data relating to the precursor ions. Quantitation may be performed using data relating to the MS1 domain.

A third method of mass spectrometry is provided. The method comprises the steps of:
analysing a sample of precursor ions having m/z values from an overall m/z range in a mass analyser, wherein analysing the sample of precursor ions having m/z values from the overall m/z range comprises obtaining scan data for the overall m/z range;
identifying one or more precursor ion species for further analysis, based on the scan data;
for each of the one or more identified precursor ion species:
   accumulating a sample of fragmented precursor ions in an ion store, wherein the sample of fragmented precursor ions comprises ions formed from fragmentation of precursor ions of the identified precursor ion species; and
   identifying a related precursor ion species and accumulating a sample of precursor ions of the related precursor ion species in the ion store;
   simultaneously analysing the combined samples of the precursor ions and the fragmented precursor ions in a mass analyser.

The sample of fragmented precursor ions and the sample of precursor ions may be combined in the ion store.

The method may further comprise, for each of the one or more precursor ion species, identifying a first m/z sub-range, wherein a m/z value of the precursor ion species is within the first sub-range.

The sample of fragmented precursor ions may comprise ions formed from fragmentation of precursor ions having m/z values within the first sub-range, including precursor ions of the identified precursor ion species.

Identifying a related precursor ion species may comprise identifying a second m/z sub-range, wherein a m/z value of the related precursor ion species is within the second sub-range.

Accumulating a sample of fragmented precursor ions in the ion store may comprise configuring an ion filter to transmit precursor ions having m/z values within the first sub-range, wherein the sample of fragmented precursor ions comprises ions formed from fragmentation of precursor ions received from the configured ion filter.

Accumulating a sample of precursor ions in the ion store may comprise configuring the ion filter to transmit precursor ions having m/z values within the second sub-range, wherein the sample of precursor ions comprises precursor ions received from the configured ion filter.

Configuring the ion filter may comprise setting a transmission window of the ion filter, wherein the transmission window is adjusted between each accumulation.

Accumulating a sample of precursor ions in the ion store may comprise configuring an ion mobility separator to transfer precursor ions having m/z values within the second sub-range to the ion filter.

Accumulating a sample of fragmented precursor ions in the ion store may comprise configuring an ion mobility separator to transfer precursor ions having m/z values within the first sub-range to the ion filter.

The ion mobility separator may be controlled so that the precursor ions transferred to the ion filter correspond with the transmission window of the ion filter.

For each of the one or more identified precursor ion species, the transmission window for the step of accumulating the sample of precursor ions may be different to the transmission window for the step of accumulating the sample of fragmented precursor ions.

The first sub-range and the second sub-range may be non-overlapping.

Advantageously, if the transmission windows (also called “isolation windows”) do not overlap, the peaks relating to the related precursor ions are distinct from peaks relating to residual unfragmented precursor ions in the injection of fragmented precursor ions.

The related precursor ion species may be an isotope of the identified precursor ion species.

The related precursor ion species may be an alternative charge state of the identified precursor ion species.

Analysing the combined samples of the precursor ions and the fragmented precursor ions in a mass analyser may comprise obtaining SIM/fragment scan data from the simultaneous analysis of the combined samples.

The method may further comprise estimating a quantity of unfragmented precursor ions accumulated in the ion store during accumulation of fragmented precursor ions by comparing an intensity of a peaks in the SIM/fragment scan data corresponding to the unfragmented precursor ions to an intensity of a peak in the SIM/fragment scan data corresponding to the sample of precursor ions (the related precursor).

Estimating a quantity of unfragmented precursor ions may be performed using one or more of:
software configured to deconvolute a plurality of fragment spectra from the SIM/fragment scan data, wherein the plurality of fragment spectra are selected from a database of fragment spectra;
a neural network configured to deconvolute a plurality of fragment spectra from the SIM/fragment scan data, wherein the plurality of fragment spectra correspond to a plurality of precursor ion species; and
a neural network configured to predict fragment spectra for the precursor ions, including intensities of m/z peaks.

Accumulating the sample of precursor ions may comprise controlling a fill time for the precursor ions, based on a relative abundance of the related precursor ion species.

The method may further comprise adjusting a collision energy used for fragmentation of the precursor ions between the step of accumulating the sample of precursor ions and the step of accumulating the sample of fragmented precursor ions.

The step of accumulating the sample of fragmented precursor ions may be performed prior to the step of accumulating the sample of precursor ions. The method may further comprise cooling the sample of fragmented precursor ions.

The fragmented precursor ions may be formed from fragmentation of precursor ions having m/z values within the first sub-range at a plurality of different collision energies.

The method may further comprise performing identification of the precursor ions based on scan data relating to the fragmented precursor ions. Identification may be performed using data relating to the MS2 domain.

A mass spectrometer configured to perform any of the methods described above is also provided.

Computer software is also provided. The computer software comprises instructions that, when executed by a processor of a computer, cause the computer to perform the any of the methods described above.

### BRIEF DESCRIPTION OF THE DRAWINGS

The invention may be put into practice in a number of ways and specific embodiments will now be described by way of example only and with reference to the following Figures.

FIG. 1 shows a schematic diagram of a mass spectrometer suitable for carrying out methods in accordance with embodiments of the invention.

FIG. 2. shows an illustrative combined SIM/MS2 spectrum, showing both strong precursor ion population and fragment distribution.

FIG. 3. Shows a first example DIA scan sequence, mixing a SIM injection into every MS2 scan.

FIG. 4 illustrates an example timing diagram for performing the example scan sequence.

FIG. 5 illustrates a second example DIA scan sequence, where each SIM and MS2 injection has its own analytical scan.

FIG. 6. illustrates an example DIA scan sequence incorporating SIM injections and stepped collision energy injections into each MS2 scan.

FIG. 7 illustrates an example DDA scan sequence incorporating SIM injections for related precursors into an MS2 scan.

### DETAILED DESCRIPTION

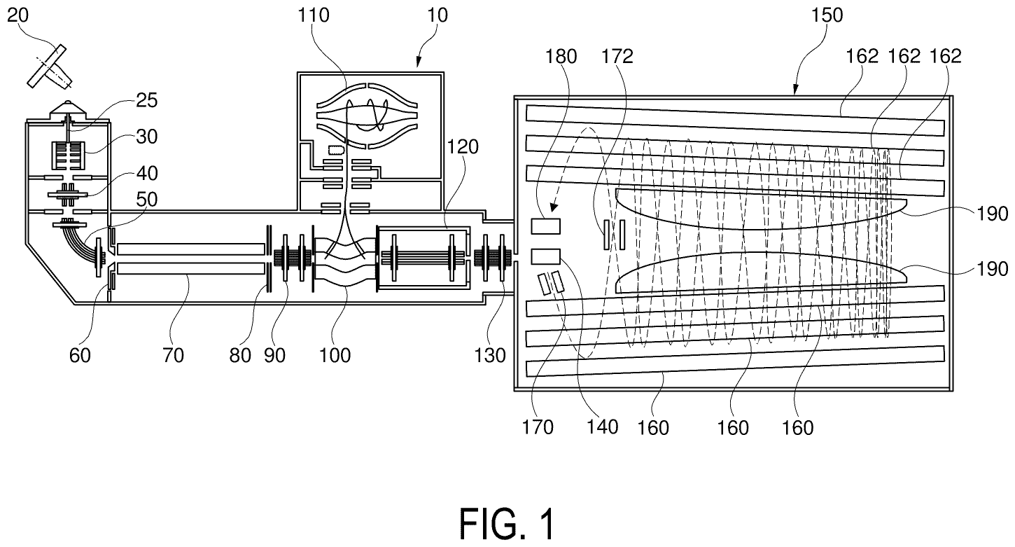

FIG. 1 shows a schematic arrangement of a mass spectrometer 10 suitable for carrying out methods in accordance with embodiments of the present invention. The mass spectrometer 10 may be a Hybrid Orbitrap multi-reflection time-of-flight mass spectrometer (MR-ToF) described in U.S. Pat. No. 10,699,888, which is incorporated by reference. The details of the mass analyser are described in U.S. Pat. No. 9,136,101, which is herein incorporated by reference.

In FIG. 1, a sample to be analysed is supplied (for example from an autosampler) to a chromatographic apparatus such as a liquid chromatography (LC) column (not shown in FIG. 1). One such example of an LC column is the Thermo Fisher Scientific, Inc ProSwift monolithic column which offers high performance liquid chromatography (HPLC) through the forcing of the sample carried in a mobile phase under high pressure through a stationary phase of irregularly or spherically shaped particles constituting the stationary phase. In the HPLC column, sample molecules elute at different rates according to their degree of interaction with the stationary phase.

A chromatograph may be produced by measuring over time the quantity of sample molecules that elute from the HPLC column using a detector (for example a mass spectrometer). Sample molecules which elute from the HPLC column will be detected as a peak above a baseline measurement on the chromatograph. Where different sample molecules have different elution rates, a plurality of peaks on the chromatograph may be detected. Preferably, individual sample peaks are separated in time from other peaks in the chromatogram such that different sample molecules do not interfere with each other.

On a chromatograph, a presence of a chromatographic peak corresponds to a time period over which the sample molecules are present at the detector. As such, a width of a chromatographic peak is equivalent to a time period over which the sample molecules are present at a detector. Preferably, a chromatographic peak has a Gaussian shaped profile, or can be assumed to have a Gaussian shaped profile. Accordingly, a width of the chromatographic peak can be determined based on a number of standard deviations calculated from the peak. For example, a peak width may be calculated based on 4 standard deviations of a chromatographic peak. Alternatively, a peak width may be calculated based on the width at half the maximum height of the peak. Other methods for determining the peak width known in the art may also be suitable.

The sample molecules thus separated via liquid chromatography are then ionized using an electrospray ionization source (ESI source) 20 which is at atmospheric pressure.

Sample ions then enter a vacuum chamber of the mass spectrometer 10 and are directed by a capillary 25 into an RF-only S lens 30 (also called an ion funnel). The ions are focused by the S lens 30 into an injection flatapole 40 (also called a quadrupole pre-filter) which injects the ions into a bent flatapole 50 with an axial field. The bent flatapole 50 guides (charged) ions along a curved path through it whilst unwanted neutral molecules such as entrained solvent molecules are not guided along the curved path and are lost. The curved path may be a 90 degree bend or an s-shaped wiggle, for example.

A TK lens 60 located at the distal end of the bent flatapole 50. Ions pass from the bent flatapole 50 into a downstream mass selector in the form of a quadrupole mass filter 70. The TK lens acts as a fringe field corrector for the quadrupole mass filter 70. The quadrupole mass filter 70 is typically but not necessarily segmented and serves as a band pass filter, allowing passage of a selected mass number or limited mass range whilst excluding ions of other mass to charge ratios (m/z). The mass filter can also be operated in an RF-only mode in which it is not mass selective, i.e. it transmits substantially all m/z ions. For example, the quadrupole mass filter 70 may be controlled by the controller to select a range of mass to charge ratios to pass of the precursor ions which are allowed to pass, whilst the other ions in the precursor ion stream are filtered (attenuated). Alternatively, the S lens 30 may be operated as an ion gate and the ion gate (TK lens) 60 may be a static lens.

Although a quadrupole mass filter is shown in FIG. 1, the skilled person will appreciate that other types of mass selection devices may also be suitable for selecting precursor ions within the mass range of interest. For example, an ion separator as described in US-A-2015287585, an ion trap as described in WO-A-2013076307, an ion mobility separator as described in US-A-2012256083, an ion gate mass selection device as described in WO-A-2012175517, or a charged particle trap as described in U.S. Pat. No. 7,999,223, which is herein incorporated by reference. The skilled person will appreciate that other methods selecting precursor ions according to ion mobility, differential mobility and/or transverse modulation may also be suitable.

The isolation of a plurality of ions of different masses or mass ranges may also be performed using the method known as synchronous precursor scanning (SPS) in an ion trap. Furthermore, in some embodiments, more than one ion selection or mass selection device may be provided. For example, a further mass selection device may be provided downstream of the fragmentation chamber 120. In this way, MS3 or MS″ scans can be performed if desired (typically using the ToF mass analyser for mass analysis).

Ions then pass through a quadrupole exit lens/split lens arrangement 80 that acts as an ion gate to control the passage of ions into a first transfer multipole 90, optionally via a charge detector (not illustrated). The first transfer multipole 90 guides the mass filtered ions from the quadrupole mass filter 70 into a curved linear ion trap (C-trap) 100. The C-trap (first ion trap) 100 has longitudinally extending, curved electrodes which are supplied with RF voltages and end caps that to which DC voltages are supplied. The result is a potential well that extends along the curved longitudinal axis of the C-trap 100. In a first mode of operation, the DC end cap voltages are set on the C-trap so that ions arriving from the first transfer multipole 90 are captured in the potential well of the C-trap 100, where they are cooled. The injection time (IT) of the ions into the C-trap determines the number of ions (ion population) that is subsequently ejected from the C-trap into the mass analyser.

Cooled ions reside in a cloud towards the bottom of the potential well and are then ejected orthogonally from the C-trap towards the first mass analyser 110. As shown in FIG. 1, the first mass analyser is an orbital trapping mass analyser 110, for example the Orbitrap® mass analyser sold by Thermo Fisher Scientific, Inc. The orbital trapping mass analyser 110 has an off centre injection aperture and the ions are injected into the orbital trapping mass analyser 110 as coherent packets, through the off centre injection aperture. Ions are then trapped within the orbital trapping mass analyser by a hyperlogarithmic electric field, and undergo back and forth motion in a longitudinal direction whilst orbiting around the inner electrode.

The axial (z) component of the movement of the ion packets in the orbital trapping mass analyser is (more or less) defined as simple harmonic motion, with the angular frequency in the z direction being related to the square root of the mass to charge ratio of a given ion species. Thus, over time, ions separate in accordance with their mass to charge ratio.

Ions in the orbital trapping mass analyser are detected by use of an image current detector (not shown) which produces a “transient” in the time domain containing information on all of the ion species as they pass the image current detector. The transient is then subjected to a Fast Fourier Transform (FFT) resulting in a series of peaks in the frequency domain. From these peaks, a mass spectrum, representing abundance/ion intensity versus m/z, can be produced.

In the configuration described above, the sample ions (more specifically, a mass range segment of the sample ions within a mass range of interest, selected by the quadrupole mass filter 70) are analysed by the orbital trapping mass analyser 110 without fragmentation. The resulting mass spectrum is denoted MS1.

Although an orbital trapping mass analyser 110 is shown in FIG. 1, other mass analysers including other Fourier Transform mass analysers may be employed instead. For example a Fourier Transform Ion Cyclotron Resonance (FTICR) mass analyser may be utilised as mass analyser for the MS1 scans. Mass analysers, such as the orbital trapping mass analyser and Ion Cyclotron Resonance mass analyser, may also be used in the invention even where other types of signal processing than Fourier transformation are used to obtain mass spectral information from the transient signal (see for example WO 2013/171313, Thermo Fisher Scientific).

In a second mode of operation of the C-trap 100, ions passing through the quadrupole exit lens/split lens arrangement 80 and first transfer multipole 90 into the C-trap 100 may also continue their path through the C-trap and into the fragmentation chamber 120, which may be an “Ion Routing Multipole” (IRM) collision cell. As such, the C-trap effectively operates as an ion guide in the second mode of operation. Alternatively, cooled ions in the C-trap 100 may be ejected from the C-trap in an axial direction into the fragmentation chamber 120. The fragmentation chamber 120 is, in the mass spectrometer 10 of FIG. 1, a high energy collisional dissociation (HCD) device to which a collision gas is supplied. Precursor ions arriving into the fragmentation chamber 120 collide with collision gas molecules resulting in fragmentation of the precursor ions into fragment ions.

Although an HCD fragmentation chamber 120 is shown in FIG. 1, other fragmentation devices may be employed instead, employing such methods as collision induced dissociation (CID), electron capture dissociation (ECD), electron transfer dissociation (ETD), photodissociation, and so forth. Moreover, ion fragmentation may be performed in a high pressure region of the extraction trap 140.

Fragmented ions may be ejected from the fragmentation chamber 120 at the opposing axial end to the C-trap 100. The ejected fragmented ions pass into a second transfer multipole 130. The second transfer multipole 130 guides the fragmented ions from the fragmentation chamber 120 into an extraction trap (second ion trap) 140. The extraction trap 140 is a radio frequency voltage controlled trap containing a buffer gas. For example, a suitable buffer gas is argon at a pressure in the range 5×10⁻⁴ mBar to 1×10⁻² mBar. The extraction trap has the ability to quickly switch off the applied RF voltage and apply a DC voltage to extract the trapped ions. A suitable flat plate extraction trap, also referred to as a rectilinear ion trap, is further described in U.S. Pat. No. 9,548,195, which is herein incorporated by reference. Alternatively, a C-trap may also be suitable for use as a second ion trap.

The extraction trap 140 is provided to form an ion packet of fragmented ions, prior to injection into the time-of-flight mass analyser 150. The extraction trap 140 accumulates fragmented ions prior to injection of the fragmented ions into the time-of-flight mass analyser 150.

Although an extraction trap (ion trap) is shown in the embodiment of FIG. 1, the skilled person will appreciate that other methods of forming an ion packet of fragmented ions will be equally suitable for the present invention. For example, relatively slow transfer of ions through a multipole can be used to affect bunching of ions, which can subsequently be ejected as a single packet to the ToF mass analyser. Alternatively orthogonal displacement of ions may be used to form a packet. Further details of these alternatives are found in US 2003/0001088 which describes a travelling wave ion bunching method, which is herein incorporated by reference.

In FIG. 1, the time-of-flight mass analyser 150 shown is a multiple reflection time-of-flight mass analyser (MR-ToF) 150. The MR-ToF 150 is constructed around two opposing ion mirrors 160, 162, elongated in a drift direction. The mirrors are opposed in a direction that is orthogonal to the drift direction. The extraction trap 140 injects ions into the first mirror 160 and the ions then oscillate between the two mirrors 160, 162. The angle of ejection of ions from the extraction trap 140 and additional deflectors 170, 172 allow control of the energy of the ions in the drift direction, such that ions are directed down the length of the mirrors 160, 162 as they oscillate, producing a zig-zag trajectory. The mirrors 160, 162 themselves are tilted relative to one another, producing a potential gradient that retards the ions' drift velocity and causes them to be reflected back in the drift dimension and focused onto a detector 180. The tilting of the opposing mirrors would normally have the negative side-effect of changing the time period of ion oscillations as they travel down the drift dimension. This is corrected with a stripe electrode 190 (to act as a compensation electrode) that alters the flight potential for a portion of the inter-mirror space, varying down the length of the opposing mirrors 160, 162. The combination of the varying width of the stripe electrode 190 and variation of the distance between the mirrors 160, 162 allows the reflection and spatial focusing of ions onto the detector 180 as well as maintaining a good time focus. A suitable MR-ToF 150 for use in the present invention is further described in US2015028197 (A1), which is herein incorporated by reference.

In one example, an MS1 scan may be performed by the first mass analyser (e.g., the orbital trapping mass analyser 110). In a second example, precursor ions may be fragmented and MS2 scans may be performed by the first mass analyser (the orbital trapping mass analyser 110) or the second mass analyser (the time-of-flight mass analyser), depending on whether the fragmentation chamber is controlled to eject the ions back towards the C-trap 100 or forwards to the second transfer multipole 130. In a further mode of operation, the second mass analyser (time-of-flight mass analyser 150) may perform MS1 scans of ions. In this mode of operation the ions are directed axially through the C-trap 100 to the fragmentation chamber, but no fragmentation gases are input and the ions are guided to the second transfer multipole 130 without fragmentation. The ions can then be accumulated into packets in the extraction trap 140, as described above.

Ions accumulated in the extraction trap are injected into the MR-ToF analyser 150 as a packet of ions, once a predetermined number of ions have been accumulated in the extraction trap. By ensuring that each packet of ions injected into the MR-ToF 150 has at least a predetermined (minimum) number of ions, the resulting packet of ions arriving at the detector will be representative of the entire mass range of interest of the MS1 or MS2 spectrum. A single packet of precursor ions or fragmented ions is sufficient to acquire MS1 or MS2 spectra of the respective ions. For MS2, this represents an increased sensitivity compared to conventional acquisition of time-of-flight spectra in which multiple spectra typically are acquired and summed for each given mass range segment. Preferably, a minimum total ion current (TIC) in each mass window is accumulated in the extraction trap before ejection to the time-of-flight mass analyser. In some examples, at least N spectra (scans) are acquired per second in the MS2 domain by the time-of-flight mass analyser, wherein N=50, or more preferably 100, or 200, or more.

Preferably, at least X % of the MS2 scans contain more than Y ion counts (wherein X=30, or 50, or 70, or most preferably 90, or more, and Y=200, or 500, or 1000, or 2000, or 3000, or 5000, or more). Most preferably, at least 90% of the MS2 scans contain more than 500 ion counts, or more preferably more than 1000 ion counts, and ideally more than 5000 ion counts. This provides for an increased dynamic range of MS2 spectra. The desired ion counts for each of the MS2 scans may be provided by adjusting the number ions included in each packet of fragmented ions. For example, in the embodiment of FIG. 1, the accumulation time of the extraction trap may be adjusted to ensure that a sufficient number of ions have been accumulated. As such, the controller may be configured to determine that a suitable packet of fragmented ions has been formed when either a predetermined number of ions are present in the extraction trap, or a predetermined period of time has passed. The predetermined period of time may be specified in order to ensure that the time-of-flight mass analyser operates at the desired frequency when the flow of ions to the extraction trap is relatively low.

The mass spectrometer 10 is under the control of a controller which, for example, is configured to control the timing of ejection of the trapping components, to set the appropriate potentials on the electrodes of the quadrupole etc. so as to focus and filter the ions, to capture the mass spectral data from the orbital trapping device 110, to capture the mass spectral data from the MR-ToF 150, control the sequence of MS1 and MS2 scans and so forth. It will be appreciated that the controller may comprise a computer that may be operated according to a computer program comprising instructions to cause the mass spectrometer to execute the steps of the method according to the present invention.

It is to be understood that the specific arrangement of components shown in FIG. 1 is not essential to the methods subsequently described. Indeed other arrangements for carrying out the methods of embodiments of the present invention are suitable. In some examples, all scans (MS1, MS2 and/or SIM) are performed by the MR-ToF analyser, which is faster than the orbital trapping analyser.

A front-end accumulation device, such as an ion mobility separator (e.g., a Trapped Ion Mobility Separator, TIMS), may be configured to release ions in an m/z range corresponding to the quadrupole isolation window. A result of this is to improve ion transmission of the quadrupole filter. As a further result of the ion mobility separator, the required injection time may be reduced (due to the isolated ion beam being brighter). This reduction in injection time may be used to at least partially offset the additional time overhead of the SIM injections.

An ion mobility separator may comprise a stacked ring ion guide, which applies a DC gradient push ions in one direction, opposed by a gas wind in the opposing direction.

In one example of an ion mobility separator, an electric field barrier in a gas flow is used to hold back ions according to their ion mobility. A decrease of the field barrier releases ions with increasing ion mobility.

The TIMS is described in detail in documents U.S. Pat. Nos. 7,838,826, 9,891,194 and Meier et al., 2018, Molecular & Cellular Proteomics 17, 2534-2545, which are herein incorporated by reference.

An extended ion funnel is comprised of a multitude of segmented electrodes, which are assembled about a common axis. The extended ion guide can be treated as three sections:
an entrance focusing section,
a mobility analysis section, and
an exit focusing section.

In the focusing sections, the distances between adjacent electrodes is approximately equal to the thickness of the electrodes. The diameter of the apertures in the electrodes is a function of the position of the electrode in the ion funnel assembly. For example, the segmented electrode having the largest aperture is at entrance end of the ion funnel and the segmented electrode having the smallest aperture is at the exit end of the ion funnel.

In some examples, the aperture diameter may be a linear function of the segmented electrode's position. In other examples, this function may be non-linear. The angle formed between common axis and the inner boundary (i.e., formed by the inner rims of the segmented electrodes) of the ion funnel may be approximately 19°. However, any angle between 0° and 90° may be used.

In the mobility analysis section of the ion funnel, the segmented electrodes may all have the same inner diameter. The space between adjacent electrodes may be filled with dielectric or electrically resistive gaskets. The thickness of the segmented electrodes should be smaller than its inner diameter and the spacing between the electrodes should be smaller than the thickness of the segmented electrodes to maintain a uniform RF field, so that the axial DC field is homogeneous near the axis.

Gaskets or o-rings between the electrodes form a substantially air tight seal so that the apertures in the electrodes form a gas tight channel through which gas may flow. Gas enters the channel in the entrance focusing section, forms a laminar stream that flows uniformly through the mobility analysis section, is constricted through the exit focusing section and then flows out through the aperture in the final electrode. The apertures are substantially cylindrically symmetric to maintain a cylindrically symmetric flow profile. In operation, a symmetric laminar flow of gas means that all ions of a given type at a given position along the axis will experience a given force due to the gas flow, substantially independent of their lateral position with respect to the axis.

A quadrupole ion filter consists of four rods equally spaced at a predetermined radius around a central axis. A radio frequency, RF, (e.g. a 1 MHz sine wave) potential is applied between the rods. The potential on adjacent rods is 180° out of phase. Rods on opposite sides of the axis of quadrupole are electrically connected, so that the quadrupole is formed as two pairs of rods. Ions travel along the axis of quadrupole and exit the quadrupole through an aperture. The RF potential applied between the rods tends to confine the ions radially. When only RF is applied between the rods, substantially all ions are transmitted through the quadrupole. Applying a DC as well as an RF potential between the pairs of rods causes ions of only a limited mass range to be transmitted through quadrupole. Ions outside this mass range are filtered away and do not reach the exit end.

The DC electric field strength varies as a function of position along the axis. However, at some position in analysis section, the field strength reaches a maximum so as to form a barrier which ions must overcome in order to reach the exit end of the funnel. Near this position of maximum field strength, the uniformity of the DC field is important because this is the point at which ions are selected on the basis of their mobility. The DC field should therefore be cylindrically symmetric.

An example method of operation comprises the steps of:
forming a DC barrier in the analysis section;
applying an RF field for focusing ions towards the axis;
generating ions in an ion source;
introducing ions in a carrier gas into the extended ion funnel;
introducing ions into the focusing section by applying potentials to the electrodes of the focusing section and/or the deflection electrode;
transferring ions into the analysis section by applying DC potentials to the electrodes of the focusing section;
optionally preventing additional ions from entering the analysis section by applying DC potentials to the deflection electrode and/or the electrodes of the focusing section;
inducing a carrier gas flow through the channel using a pump downstream from the exit end of the funnel;
gradually reducing the DC barrier in the analysis section to allow the carrier gas flow to push ions from the group of ions over the DC barrier in order of the ions' mobilities; and
focusing ions through the aperture in the exit electrode.

In another example, a DC gradient is used to push ions out, opposed by a gas wind. As the DC potential is increased, ions are released in order of mobility.

In one example method, a full mass scan is performed by the Orbitrap mass analyser 110 with a long acquisition transient, generating high-resolution MS1 spectra. In parallel to this, the MR-ToF 150 analyser performs a series of MS2 acquisitions with very fast scanning speed and high sensitivity.

An example method for combined ion injection and analysis is described in U.S. Pat. No. 8,686,350, which is herein incorporated by reference.

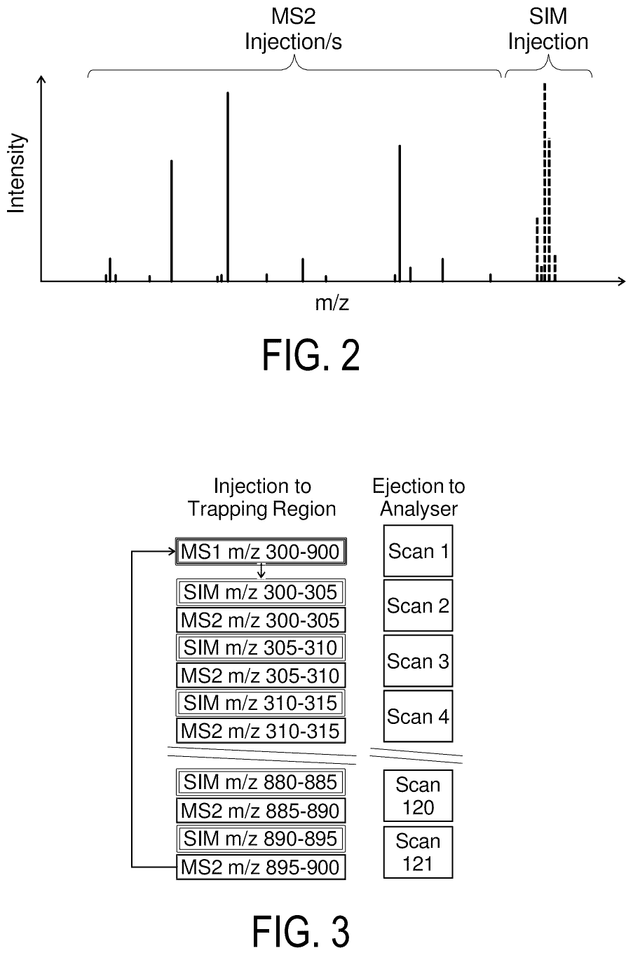

An example method described herein accumulates and combines different types of ions in an ion trap with two injections: a first injection of ions that have been fragmented and a second injection of ions that are left as intact precursor ions (the first and second ion injections may be performed in either order). The ions may come from the same ion source and with the same quadrupole isolation window but with different fragmentation energies (a collision energy of zero for the precursor injection). The combined ions are then analysed in a mass analyser to provide an analytical scan, such as that drawn in FIG. 2. Such a scan provides precursor information (illustrated as SIM injection in FIG. 2), in addition to the fragment spectra (illustrated as MS2 Injection/s in FIG. 2). The spectrum may be recorded quickly, as there is no additional quadrupole switching time, and the additional inject time for the precursor ion (SIM) component should be lower than for the fragmentation injection. Some delay is required to either cool the fragments, or switch to high collision energy, depending on whether the fragmentation or SIM injection is performed first.

In a DIA method according to some specific examples in accordance with the invention, for every injection that is performed with fragmentation, there is an additional injection with the same quadrupole isolation window and reduced or no collision energy. The target mass is scanned through a predetermined range and isolation step size as is normal for DIA. FIG. 3 shows such a scan sequence from m/z 300-900 Th, with 5 Th isolation windows, as may be used for “bottom-up” measurement of digested protein samples. An optional MS1 full scan is also performed with every cycle through the mass range. On the hybrid Orbitrap/MR-ToF instrument of FIG. 1, this MS1 scan would be performed on the Orbitrap™ mass analyser and the SIM/MS2 scans performed by the MR-ToF mass analyser. If all the SIM injection spectra are overlaid, an extreme HDR MS1 scan can be generated. As will be appreciated by the skilled person, actually overlaying the spectra is not required. For the purposes of data processing, it is sufficient that the data from all the SIM injection spectra are available.

The method of FIG. 3 could be performed on the combined Orbitrap mass analyser and MR-ToF instrument illustrated in FIG. 1. Alternatively, the method could be performed on a single mass analyser instrument, such as a ToF-only instrument or an Orbitrap mass analyser-only instrument (and may take longer).

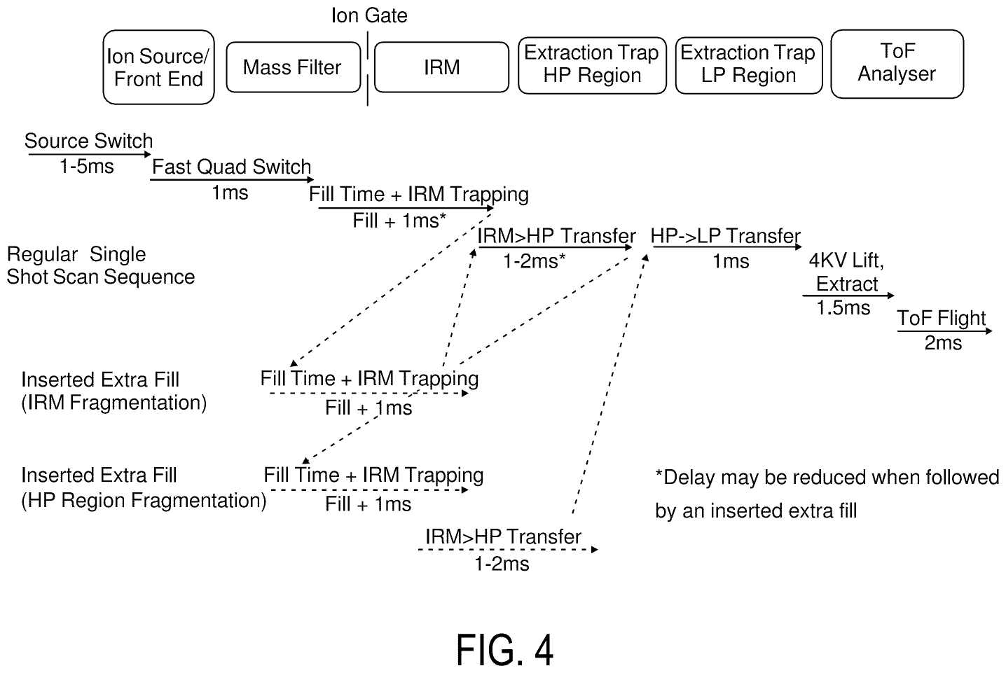

FIG. 4 illustrates an example timing diagram for performing the method illustrated in FIG. 3 on a combined Orbitrap mass analyser and MR-ToF instrument, as illustrated in FIG. 1. As can be seen in FIG. 4, the timings of the different operations may be configured so that certain operations are performed in parallel, to reduce the overall time taken. The Orbitrap/MR-ToF instrument illustrated in FIG. 1 may be capable of running single injections at approximately 200 Hz with a 3 ms inject time (also referred to as “fill time”) and 2 ms overhead. Additional overhead would deplete the duty cycle and reduce instrument sensitivity.

Illustrative timings for the steps of ion injection and transport through components of the mass spectrometer are illustrated in FIG. 4. The ions are transported from the ion source through to the analyser. The vertical displacement in FIG. 4 provides an indication of parallelism, as multiple separate ion packets may be processed simultaneously in the different components.

As illustrated in FIG. 4, extra SIM/MS2 injections may be interleaved, dependent on whether fragmentation is carried out in the IRM 120 or the high-pressure region of the extraction trap 140. Additional injections (also referred to as “fills”) may be made into the ion store (also referred to as the “extraction trap”), in such a way as to minimise additional overhead. The additional injections may relate to precursor ions from the ion filter having the same m/z characteristics. During operation according to some example methods, the collision energy of the fragmentation chamber may be adjusted. The fragmentation energy may be adjusted from a pre-set MS2 level, which is used to produce the sample of fragmented precursor ions, to a reduced level such as zero so that the precursor ions pass through the fragmentation chamber unfragmented.

The ions from differing injections should not be mixed before the fragmentation step. If fragmentation is performed in the IRM collision cell 120 then the second injection follows the first after a short delay required to change the IRM offset and cool the ions of the first injection. Both packets of ions may then be mixed and transferred to the extraction trap 100, 140. However, if fragmentation is performed by the high-pressure region of the extraction trap 140, the IRM collision cell 120 must be cleared of the first ion packet before admitting the second ion packet. Effectively, this adds an extra transfer stage and slows down the instrument operation. Nevertheless, because the second injection has the same m/z range as the first injection, the need to thoroughly clear regions of ions between injections is lessened. Delay times for the transfer and cooling stages may therefore be reduced to compensate for some of the lost duty cycle (and reduce the time taken).

It is desirable that any residual unfragmented precursor from the MS2 injection be accounted for. Otherwise, the fixed amount from the SIM injection will add to an unknown quantity of unfragmented precursor, which would make the SIM data less reliable for quantitation purposes. For a single precursor species this may be achieved by summing up all ions in the spectrum. However, for DIA and wide-window DDA, MS2 spectra are typically chimeric, containing more than one precursor ion. There are two potential ways to estimate the quantity of unfragmented precursor from the MS2 injection in this case, which are described in more detail below.

In a first method, prediction of the residual amount of unfragmented precursor from the MS2 injection based on the known fragmentation pattern of the identified precursors. Bioinformatics solutions such as Chimerys™ AI-based search engine (MSAID GmbH, Germany) is able to predict both fragmentation pattern and relative intensities of fragments as well as residual precursors. For example, if we stored 3 ms for MS2 and 1 ms for SIM, then we need to correct by 1.6-fold. However, if in reality the proportion of residual precursor was one-quarter off (e.g. 15% instead of 20%) because of some experimental error, this will result in <10% error of the total in this example (1.45× instead of 1.6×), i.e. still much better than without SIM.

In a second method, the quadrupole isolation window may be shifted to the adjacent mass range for SIM during scan storage. For example, MS2 may be performed for mass range 300-305 Th and SIM may be performed mass range 305-310 Th may be added and acquired in Scan 2. However, in order to achieve this, complex interruption of ion flow may be required. Moreover, there may be dead time during adjustment of the quadrupole isolation window. One benefit of this method is that the intensities of the peaks in the SIM scan do not require correction, due to the fact that the m/z window just above precursor m/z values are usually fairly empty of ions.

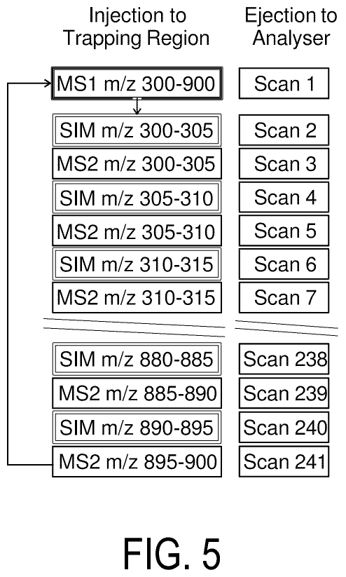

An alternative DIA method is illustrated in FIG. 5. Instead of accumulating multiple injections per mass spectrum, each MS2 and SIM injection has its own analytical scan in this second method. This is particularly suitable when one or both of the scans are carried out on an MR-ToF analyser, which it is considerably faster than an Orbitrap mass analyser. The time overhead is also larger for an Orbitrap mass analyser, so that MS2+SIM scan generation frequency may be limited to around 50 Hz using the Orbitrap instrument. The two scans (MS2 and SIM) may be summed to produce spectra similar to those produced by the method of FIG. 3, though this is not necessary for analysis.

One advantage of making separate scans is that the SIM scan may be recorded via a “Zoom Mode”, where a narrow mass range undergoes multiple passes through the MR-ToF analyser to produce higher resolution. This method is described in UK Patent Application Number 2300355.1, which is herein incorporated by reference. Another form of Zoom mode described in UK Patent Application Number 2208939.5 (which is herein incorporated by reference) involves selecting only a narrow mass range and applying zoom mode to it alone, whilst the remaining ions fly normally. This method is in-principle suitable for multiple injection spectra where one desires high resolution precursor information but unambiguous m/z assignment and maximum sensitivity for the fragments. For Orbitrap mass analyser scans the closest equivalent method of achieving higher resolution over a narrow mass band is to apply Phi-SDM analysis of the transient, limited to the precursor frequency range (Bekker-Jenson et al, Mol. Cell. Proteomics, 2020, 19, 716-729).

Each mass analysis procedure may produce a time-varying transient signal. A mass spectrum may be produced from each time-varying transient signal by deconvolving the transient signal using a deconvolution technique. In particular embodiments, the deconvolution technique is a high-resolution deconvolution technique such as the “phase-constrained spectrum deconvolution method” (also known as ϕSDM), i.e. as described in Grinfeld, et al., “Phase-constrained spectrum deconvolution for Fourier transform mass spectrometry”, Anal. Chem., 89 (2): 1202-1211 (2017), and also European Patent Application No. EP 3,086,354 the entire contents of which is incorporated herein by reference.

As is described in European Patent Application No. EP 3,086,354, in these embodiments, a Fourier transform of the transient signal is performed to produce a first set of complex amplitudes, where each of the complex amplitudes corresponds to a respective frequency of a first set of frequencies. The first set of frequencies may be equally spaced in frequency. A second set of complex amplitudes is generated, where each of these complex amplitudes corresponds to a respective frequency of a second set of frequencies. The second set of frequencies may be equally spaced in frequency. The second set of frequencies may have a spacing (or a minimum spacing) that is less than that of the first set of frequencies. The second set of frequencies may have a spacing (or a minimum spacing) that is less than the inverse of the duration of the transient signal. The second set of complex amplitudes may cover (or span or correspond to) the same frequency range as the first set of complex amplitudes, and so the second set may contain more complex amplitudes than the first set. Hence, the second set of complex amplitudes may provide greater resolution.

The second set of complex amplitudes may be optimized to produce an improved second set of complex amplitudes. At least some of the complex amplitudes from the improved second set may be used to generate the mass spectrum. The improved second set of complex amplitudes may provide a better-quality mass spectrum.

Optimizing the second set of complex amplitudes may comprise varying at least one of the complex amplitudes of the second set based on (or in dependence on) an objective function. For example, the at least one complex amplitudes may be varied with the aim of obtaining a substantially extremum value of the objective function. Optionally, all of the complex amplitudes from the second set may be varied as part of the optimizing step, or a subset may be optimized as part of the optimizing step.

The optimization may be performed subject to a constraint. That is, for at least some of the complex amplitudes of the second set, a constraint may be placed on the phase of each of the at least some complex amplitudes relative to one or more expected phases. The expected phases may be frequency-dependent. The objective function may depend on one or more complex amplitudes of the first set of complex amplitudes and one or more complex amplitudes of the second set of complex amplitudes. The objective function may, for each frequency of the first set of frequencies, relate one or more complex amplitudes of the second set to the respective complex amplitude from the first set (such as by having the objective function a function of the one or more complex amplitudes of the second set and the respective complex amplitude from the first set). The constraint may be applied to all the complex amplitudes of the second set that are being varied as part of the optimizing step, or to a subset of those complex amplitudes.

By generating and optimizing a second set of complex amplitudes, the transient may be thought of as being decomposed onto a finer frequency grid. As the second set of complex amplitudes is not bound to the first set of complex amplitudes as a linear combination of these amplitudes, the resolution increases as the grid spacing of the second set of frequencies decreases. This leads to a much-increased accuracy of the resulting mass spectrum. In other words, the ϕSDM method may be thought of as operating with two sets of frequencies. The first set of frequencies may comprise frequencies with a minimum separation of 1/T, where T is the time duration of the transient signal. The second set of frequencies may comprise the frequencies with a minimum separation less than 1/T. The second set of frequencies may contain the first set as a subset. Since the minimum spacing of the second set is less than that of the first set of frequencies, the second set of complex amplitudes may provide greater resolution.

It will be appreciated that “complex” is to be understood as relating to a number that can be expressed with a real and imaginary part. The imaginary part may be zero (i.e., complex as used herein covers real numbers).

One advantage of the ϕSDM method is the integrability of the mass spectrum produced. In other words, the intensity of all peaks, both resolved and unresolved, is conserved. As such, suppression effects of the conventional Fourier transform approach, caused by the interference of adjacent peaks is avoided. Thus the ϕSDM method is of particular benefit where highly accurate intensity information is desired. Moreover, computations can be conducted on shorter transients increasing the speed and throughput of the instrument.

In some embodiments, the step of performing a Fourier transform includes windowing the Fourier-transformed transient signal in the frequency domain, wherein the first set of complex amplitudes correspond to the windowed Fourier-transformed transient signal. This windowing may comprise applying a windowing function to the first set of complex amplitudes. Typically, applying a windowing function includes scaling each complex amplitude of the first set of complex amplitudes by the value of the windowing function at the respective frequency. Additionally, or alternatively, the windowing may comprise discarding the complex amplitudes whose respective frequency is outside of one or more pre-defined ranges. For example, complex amplitudes of the first set of complex amplitudes whose respective frequency is above the Nyquist frequency of the transient signal may be discarded, and/or set to zero.

Advantageously, this may allow an increase in processing speed and reduction of computational burden, as the subsequent processing may be limited to regions of interest only. For a sparse enough spectrum or sparse enough segments of interest, calculations can be carried only within windows of the spectra encapsulating these regions.

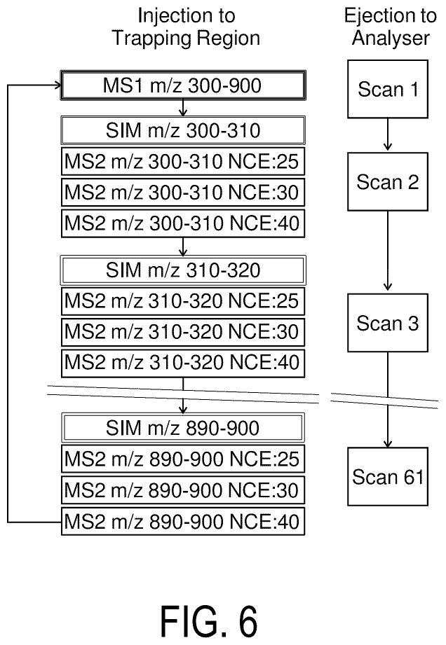

A further modification of the DIA process of FIG. 3 is illustrated in FIG. 6. This method is a variation of the first method, as the SIM ions are mixed with fragment ions in the ion store and analysed together in a single scan. In this method, in addition to the SIM injection, stepped fragmentation energies are also applied for each MS2 scan. In other words, the MS2 ions are added to the ion store in multiple injections, each injection having a different fragmentation energy.

In some variations of the methods, it may be preferable not to perform SIM scans for m/z sub-ranges of the overall precursor mass range that are already heavily populated. This may be determined from full-MS scans, which should be able to gather sufficient data for such regions by themselves. Omitting SIM scans for these sub-ranges may further reduce the time required for the overall method. A HDR MS1 scan can be obtained by combining the full-MS1 scan with the SIM scans.

SIM scanned precursor ions may be compared to the full MS and used as an internal calibrant, this is especially useful when SIM scans are performed by a jitter-prone MR-ToF analyser and full MS by a more stable Orbitrap analyser, in a hybrid instrument.

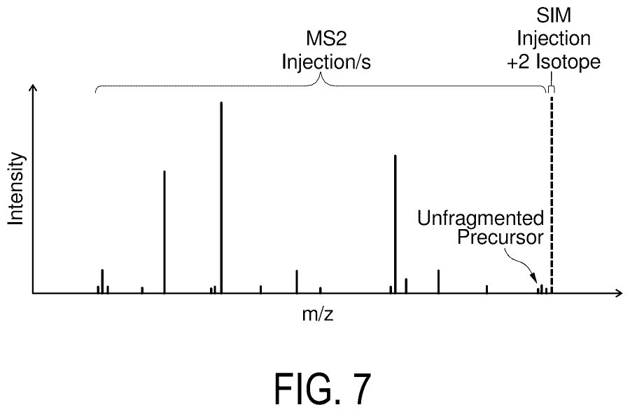

A further modification of the process of FIG. 3 is illustrated in FIG. 7. In this method, SIM scanned precursor ions are obtained from a specific isolation window and used as an internal calibrant in a DDA method. This method is a variation of the first method, as the SIM ions are mixed with fragment ions in the ion store and analysed together in a single scan.

In the alternative method of FIG. 7, fragments of the main precursor are accumulated in an ion store and combined with a sample of precursor ions that are related to the main precursor. The related precursor ions are accumulated in a zero collision energy injection. The presence of the related precursor ions in the scan data may be used to quantify on an isotope of the main precursor or on a different charge state of the main precursor (as commonly detected in the full MS scan). As a result, convolution between quantification precursor ions (from the zero collision energy injection) with overlapping unfragmented precursor from the fragment injection (the injection with non-zero collision energy) may be avoided. As can be seen in FIG. 7, the SIM injection is separate from the unfragmented precursor.

Differences in proportion of isotopes could be calculated from theory, and charge states would still respond to relative behaviour.

In contrast to methods described earlier, the transmission window may be adjusted between injections.

One reason for this is to exclude the related precursor (e.g., isotope or different charge state ion) from the injection with non-zero collision energy. Another reason is to exclude the main precursor from the injection with zero collision energy.

Where the related precursor is an isotope of the main precursor, the transmission window may be moved by a very small distance between injections. Advantageously, this may cause a negligible time delay.

The isolation window for the related precursor may be small to limit overlap between the two injections (especially where the windows are close, as when the related precursor is an isotope of the main precursor). In some examples, the related precursor ion species may be the only precursor ion species transmitted by the ion filter in the precursor ion injection.

Where the related precursor is a different charge of the main precursor, the transmission window may be moved by a larger distance and the scan rate may be affected.

An isolation window for the related precursor may be selected based on full MS scan data. The proposed method may therefore be a DDA method.

Where the related precursor is an isotope of the main precursor, the isolation window may be selected precisely based on the scan data.

Where the related precursor is a different charge state of the main precursor, the scan data may be used to identify where to target the SIM scan to acquire the different charge state and set the isolation window accordingly.

Where the related precursor is a different charge state of the main precursor, a higher charge state may be selected to avoid contamination from a charge stripped precursor.

Herein the term mass may be used to refer to the mass-to-charge ratio, m/z. The resolution of a mass analyser is to be understood to refer to the resolution of the mass analyser as determined at a mass to charge ratio of 200 unless otherwise stated.

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that, for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise.

Unless otherwise defined, all other technical and scientific terms used herein have the meaning commonly understood by one of ordinary skill in the art to which this invention belongs. In case of conflict, the present specification, including definitions, will control. It will be appreciated that there is an implied “about” prior to the quantitative terms mentioned in the present description, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. As used herein, “a” or “an” also may refer to “at least one” or “one or more.” Also, the use of “or” is inclusive, such that the phrase “A or B” is true when “A” is true, “B” is true, or both “A” and “B” are true.

As used in this document, the term “scan”, when used as a noun, means a mass spectrum, regardless of the type of mass analyzer used to generate and acquire the mass spectrum. When used as a verb herein, the term “scan” refers to the generation and acquisition of a mass spectrum by a method of mass analysis, regardless of the type of mass analyzer or mass analysis used to generate and acquire the mass spectrum. As used herein, the term “full scan” refers to a mass spectrum than encompasses a range of mass-to-charge (m/z) values that includes a plurality of mass spectral peaks.

As used in this document, each of the terms “liquid chromatograph” and “liquid chromatography” (both abbreviated “LC”) as well as the term “Liquid Chromatography Mass Spectrometry” (abbreviated as “LC-MS”) are intended to apply to any type of liquid separation system that is capable of separating a multi-analyte-bearing liquid sample into various “fractions” or “separates”, where the chemical composition of each such “fraction” or “separate” is different from the chemical composition of every other such fraction or separate, wherein the term “chemical composition” refers to the numbers, concentrations, and/or identities of the various analytes in a fraction or separate. As such, the terms “liquid chromatograph”, “liquid chromatography” “Liquid Chromatography Mass Spectrometry”, “LC”, and “LC-MS” are intended to include and to refer to, without limitation, liquid chromatographs, high-performance liquid chromatographs, ultra-high-performance liquid chromatographs, size-exclusion chromatographs and capillary electrophoresis devices.

Instead of the LC device any other separation device, including an ion mobility device, HPLC, GC or ion chromatography could be interfaced to the mass spectrometer. Also any known fragmentation method (including collisionally activated dissociation, photon induced dissociation, electron capture or electron transfer dissociation) produces data suitable for use with the invention.

1. A method of mass spectrometry comprising the steps of:
for each of a plurality of sub-ranges selected from an overall m/z range:
accumulating in an ion store a sample of precursor ions to be analysed, the precursor ions having m/z values within the sub-range;
accumulating in the ion store a sample of fragmented precursor ions to be analysed, the fragmented precursor ions being formed from fragmentation of precursor ions having m/z values within the sub-range; and
simultaneously analysing the combined samples of the precursor ions and the fragmented precursor ions in a mass analyser.

2. The method of claim 1, further comprising estimating a quantity of unfragmented precursor ions accumulated in the ion store during accumulation of fragmented precursor ions.

3. The method of claim 2, wherein the method further comprises obtaining scan data from the simultaneous analysis of the combined samples, wherein estimating a quantity of unfragmented precursor ions is performed using one or more of:
software configured to deconvolute a plurality of fragment spectra from the scan data, wherein the plurality of fragment spectra are selected from a database of fragment spectra;
a neural network configured to deconvolute a plurality of fragment spectra from the scan data, wherein the plurality of fragment spectra correspond to a plurality of precursor ion species; and
a neural network configured to predict fragment spectra for the precursor ions, including intensities of m/z peaks.

4. The method of claim 1, further comprising:
for each of the plurality of sub-ranges, configuring an ion filter to transmit precursor ions having m/z values within the sub-range, wherein configuring the ion filter comprises setting a transmission window of the ion filter, wherein the transmission window is adjusted between each of the plurality of sub-ranges, wherein for each sub-range, the transmission window for the step of accumulating the sample of precursor ions is the same as the transmission window for the step of accumulating the sample of fragmented precursor ions.

5. The method of claim 1, wherein accumulating the sample of precursor ions comprises controlling a fill time for the precursor ions, based on a relative abundance of precursor ion species in the corresponding sub-range.

6. The method of claim 1, wherein the plurality of sub-ranges comprises a first sub-range and a second sub-range, wherein the step of analysing the combined samples of the precursor ions and the fragmented precursor ions from the first sub-range at least partially overlaps with the step of:
accumulating the sample of precursor ions having m/z values within the second sub-range; and/or
accumulating the sample of fragmented precursor ions formed from fragmentation of precursor ions having m/z values within the second sub-range.

7. The method of claim 1, further comprising adjusting a collision energy used for fragmentation of the precursor ions between the step of accumulating the sample of precursor ions and the step of accumulating the sample of fragmented precursor ions.

8. The method of claim 1, wherein for each sub-range the step of accumulating the sample of fragmented precursor ions is performed prior to the step of accumulating the sample of precursor ions, wherein the method further comprises cooling the fragmented precursor ions.

9. A method of mass spectrometry comprising the steps of:
for each of a plurality of sub-ranges selected from an overall m/z range:
configuring an ion filter to transmit precursor ions having m/z values within the sub-range;
analysing a sample of the precursor ions received from the configured ion filter in a mass analyser; and
analysing a sample of fragment ions that are produced by fragmenting precursor ions received from the configured ion filter in the mass analyser.

10. The method of claim 9, further comprising:
accumulating the sample of the precursor ions in an ion store, wherein accumulating the sample of precursor ions in an ion store comprises controlling a fill time for the precursor ions, based on a relative abundance of precursor ion species in the corresponding sub-range.

11. The method of claim 9, wherein configuring the ion filter comprises setting a transmission window of the ion filter, wherein the transmission window is adjusted between each of the plurality of sub-ranges, wherein for each sub-range, the transmission window for receiving the sample of precursor ions from the configured ion filter is the same as the transmission window for receiving precursor ions from the configured ion filter that are fragmented to produce the sample of fragment ions.

12. The method of claim 1, wherein the mass analyser is a time-of-flight, ToF, analyser, preferably a multi-reflection time-of-flight, MR-ToF, analyser, wherein analysing a sample of the precursor ions comprises passing the precursor ions through the MR-ToF analyser a plurality of times.

13. The method of claim 4, further comprising configuring an ion mobility separator to transfer precursor ions having m/z values within the sub-range to the ion filter, further comprising controlling the ion mobility separator so that the precursor ions transferred to the ion filter correspond with a transmission window of the ion filter, for each of the plurality of sub-ranges in the overall m/z range.

14. The method of claim 1, wherein the fragmented precursor ions are formed from fragmentation of precursor ions having m/z values within the sub-range at a plurality of different collision energies.

15. The method of claim 1, wherein the plurality of sub-ranges are contiguous, the method further comprising:
for each sub-range, obtaining scan data relating to the precursor ions; and
combining the scan data relating to the precursor ions for each sub-range to form a high-definition scan for the overall m/z range.

16. The method of claim 1, wherein the overall m/z range comprises a second plurality of sub-ranges that are non-overlapping with the plurality of sub-ranges, wherein the method further comprises:
for each of the second plurality of sub-ranges:
analysing, in a mass analyser, a sample of fragmented precursor ions formed from fragmentation of precursor ions having m/z values within the sub-range.

17. The method of claim 1, further comprising:
analysing a sample of precursor ions having m/z values from the overall m/z range in a mass analyser, wherein analysing the sample of precursor ions having m/z values from the overall m/z range comprises obtaining scan data for the overall m/z range;
for each sub-range, obtaining scan data relating to the precursor ions; and either
augmenting the scan data for the overall m/z range using the scan data relating to the precursor ions for each sub-range, to form a high-definition scan for the overall m/z range, or
comparing the scan data for the overall m/z range to the scan data relating to the precursor ions for each sub-range, and adjusting one of the scan data for the overall m/z range or the scan data relating to the precursor ions for each sub-range based on the other of the scan data for the overall m/z range or the scan data relating to the precursor ions for each sub-range.

18. The method of claim 1, further comprising:
analysing a sample of precursor ions having m/z values from the overall m/z range in a mass analyser; and
determining the plurality of sub-ranges from the overall m/z range, based on scan data obtained from analysis of the sample of precursor ions having m/z values from the overall m/z range.

19. A method of mass spectrometry comprising the steps of:
analysing a sample of precursor ions having m/z values from an overall m/z range in a mass analyser, wherein analysing the sample of precursor ions having m/z values from the overall m/z range comprises obtaining scan data for the overall m/z range;
identifying one or more precursor ion species for further analysis, based on the scan data;
for each of the one or more identified precursor ion species:
accumulating a sample of fragmented precursor ions in an ion store, wherein the sample of fragmented precursor ions comprises ions formed from fragmentation of precursor ions of the identified precursor ion species; and
identifying a related precursor ion species and accumulating a sample of precursor ions of the related precursor ion species in the ion store;
simultaneously analysing the combined samples of the precursor ions and the fragmented precursor ions in a mass analyser.

20. The method of claim 1, wherein the method is performed within a time period based on a width of a chromatographic peak of the sample as it elutes from a chromatography system.

21. A mass spectrometer configured to perform the method of claim 1.

22. Computer software comprising instructions that, when executed by a processor of a computer, cause the computer to perform the method of claim 1.
